(19) United States
(12) Patent Application Publication
(10) Pub. No.: US 2008/0175754 A1
(43) Pub. Date: Jul. 24, 2008

(54) Leakage Detection Patch

(75) Inventors: Pierre Orlewski, Ettelbruck (PL); Cecile Jouanique-Dubuis, Evrange (FR)

Correspondence Address: CANTOR COLBURN, LLP, 20 Church Street, 22nd Floor, Hartford, CT, 06103, US

(73) Assignee: IEE International Electronics & Engineering S.A., Echternach (LU)

(21) Appl. No.: 11/911,758

(22) PCT Filed: Apr. 20, 2006
(86) PCT No.: PCT/EP06/61700

§ 371 Date: Oct. 17, 2007

(30) Foreign Application Priority Data
Apr. 20, 2005 (EP) 05103154.0

(51) Int. Cl. G01N 21/77

(52) U.S. Cl. 422/55

(57) ABSTRACT

A leakage detection patch (10) for a modified atmosphere package comprises a substrate (12) and an oxygen sensing spot (14) arranged thereon. The oxygen sensing spot contains an oxygen indicator, which may be interrogated remotely An adhesive strip (16) for fixing the leakage detection patch to a package surface of the 5 modified atmosphere package extends peripherally around the sensing spot. The leakage detection patch further comprises means (20) enabling oxygen diffusion between the modified atmosphere and the oxygen sensing spot.

### BACKGROUND OF THE INVENTION

There is a demand in the packaging industry for determining certain parameters of a modified atmosphere package in a non-destructive way. The parameters to be sensed include temperature, pressure, moisture, pH, gas concentrations (e.g. CO₂, CO, NH₄, O₂) or ion concentrations (e.g. ammonia).

Depending on the nature of the goods to be packaged, the package atmosphere has to comply with certain parameter ranges. Exposure of chemical, pharmaceutical and electronic products to inappropriate temperature, moisture or oxygen concentration can lead to premature degradation of the packaged product. Monitoring the relevant parameters is thus necessary for assuring quality of packaged goods.

An important issue is the integrity of the package. Air leakage into the package may raise the oxygen concentration and hence cause degradation of the packaged good. Standard oxygen concentration measurements are presently destructive thus do not allow a full control of all the packages. Sampling inspection however cannot guarantee that all the packaged goods meet the quality criteria. Another disadvantage is the loss of a certain fraction of the packaged products, as the testing procedure destroys at least the package. Inspecting the goods directly on the shelves is not practicable with such a technique.

### SUMMARY OF THE INVENTION

It is an object of the present invention to provide a leakage detection means, which allows non-destructive testing of oxygen concentration of a packaged good. This is achieved by a leakage detection patch according to claim 1.

A leakage detection patch for a modified atmosphere package comprises a substrate and an oxygen sensing spot arranged thereon. The oxygen sensing spot contains an oxygen indicator, which may be interrogated remotely. An adhesive strip for fixing the leakage detection patch to a package surface of the modified atmosphere package extends peripherally around the sensing spot. The leakage detection patch further comprises means enabling oxygen diffusion between the modified atmosphere and the oxygen sensing spot.

Such a leakage detection patch can be placed into every package containing a good, which requires the monitoring of the oxygen concentration of the modified atmosphere in the package. Detection of oxygen leakage is achieved by determining certain optical properties of the oxygen indicator contained in the sensing spot, e.g. fluorescence lifetime and/or fluorescence intensity. The relation between fluorescence lifetime and oxygen concentration is given by the first Stern-Volmer relation:

t₀/t=1+C_{SV}·[O₂],

where t₀ is the fluorescence lifetime at oxygen concentration zero, t is the fluorescence lifetime at a specific oxygen concentration. C_{SV} is the Stern-Volmer constant and [O₂] is the oxygen concentration.

The relation between fluorescence intensity and oxygen concentration is given by the second Stern-Volmer relation:

I₀/I=1+C_{SV}·[O₂],

where I₀is the fluorescence lifetime at oxygen concentration zero, I is the fluorescence lifetime at a specific oxygen concentration. C_{SV} is the Stern-Volmer constant and [O₂] is the oxygen concentration.

Determining the optical properties of the oxygen indicator can be done optically through the packaging foil, which means that destroying the package is no longer necessary for determining the oxygen concentration in the modified atmosphere. The non-destructiveness of the testing will be very much appreciated, as every single package can thus be tested, which allows optimal quality control.

In case of a food package (containing e.g. meat or fish), the materials of the leakage detection spot are preferably food-compliant. The substrate may comprise a soft and stretchable polymer. The oxygen sensing spot and the adhesive strip may be printed on the substrate.

The oxygen indicator may comprise a Ruthenium compound (e.g. Rull(Dpp)₃) for sensing partial O₂ pressure. The sensing spot may further comprise a temperature indicator, e.g. Oregon Green Dye or any other indicator for different kinds of gases or vapours (e.g. CO, NO, NO₂, N₂O, ethylene or ethanol).

Sensing compounds being relatively expensive, it will be appreciated that the invention provides a small sensing spot, which is easily fixable to the package. Techniques, which print the sensing spot directly on the packaging foil cannot guarantee that only one spot is used per final package. The leakage detection patch of the present invention can e.g. be supplied by a pick-and-place machine. Inserting such an application step into an existing packaging process can be done without severe process flow modifications.

The leakage detection patch proposed by the invention can be integrated into the packaging decoration, by appropriate shaping or patterning of the patch. Optionally, the precise atmosphere description of the package can be provided on the visible side of the patch e.g. as a bar code. The read-out device can thus compare the actual oxygen concentration with the value encoded in the bar code. A warning may be issued if the actual oxygen concentration differs more than tolerably from the target value. Additionally, the tolerance range may also be encoded in the bar code.

According to a preferred embodiment of the invention, the means enabling oxygen diffusion during use of the patch comprise the substrate being permeable for oxygen. The substrate preferably has a transmission rate greater than 100 cm³/m²/24 hrs@25° C., 0% RH, 1 atmosphere.

Alternatively or additionally, the means enabling oxygen diffusion comprise the adhesive strip having at least one opening. Such an opening enables direct diffusion of the oxygen from the modified atmosphere to the sensing spot. The number of openings may depend on the target diffusion speed. The adhesive strip may have the appearance of a segmented ring with openings regularly arranged around the periphery of the sensing spot.

In order to limit the diffusion of vapours or liquids through the at least one opening, the latter may have a labyrinthal shape, such that there is no straight path from the surrounding modified atmosphere to the sensing spot. In a specific embodiment, the adhesive strip comprises at least a first and a second adhesive ring, which are substantially concentric and spaced from each other. The first adhesive ring and the second adhesive ring comprise each at least one opening, such that these openings are staggered in angular direction.

For use along a sealed opening of a package the patch may have an elongated shape.

If more protection of the sensing spot is required, the leakage detection patch may comprise a transparent sealing layer on top of the oxygen sensing spot. This sealing layer may be food-compliant, flexible, stretchable, and/or oxygen-permeable. It may be welded with the substrate around the sensing spot. The adhesive strip may be applied on the substrate or on the transparent sealing layer for fixing the leakage detection patch to the package.

The invention further proposes a seal for a modified atmosphere package comprising a leakage detection patch.

### BRIEF DESCRIPTION OF THE DRAWINGS

Preferred embodiments of the invention will now be described with reference to the accompanying drawings in which:

FIG. 1: is a top view of a first embodiment of a leakage detection patch;

FIG. 2: is a top view of a second embodiment of a leakage detection patch;

FIG. 3: is a top view of a third embodiment of a leakage detection patch;

FIG. 4: is a cross sectional view of a modified atmosphere package with a first leakage detection patch;

FIG. 5: is a cross sectional view of a modified atmosphere package with a second leakage detection patch;

FIG. 6: is a cross sectional view of a modified atmosphere package with a seal comprising a leakage detection patch.

### DESCRIPTION OF A PREFERRED EMBODIMENT

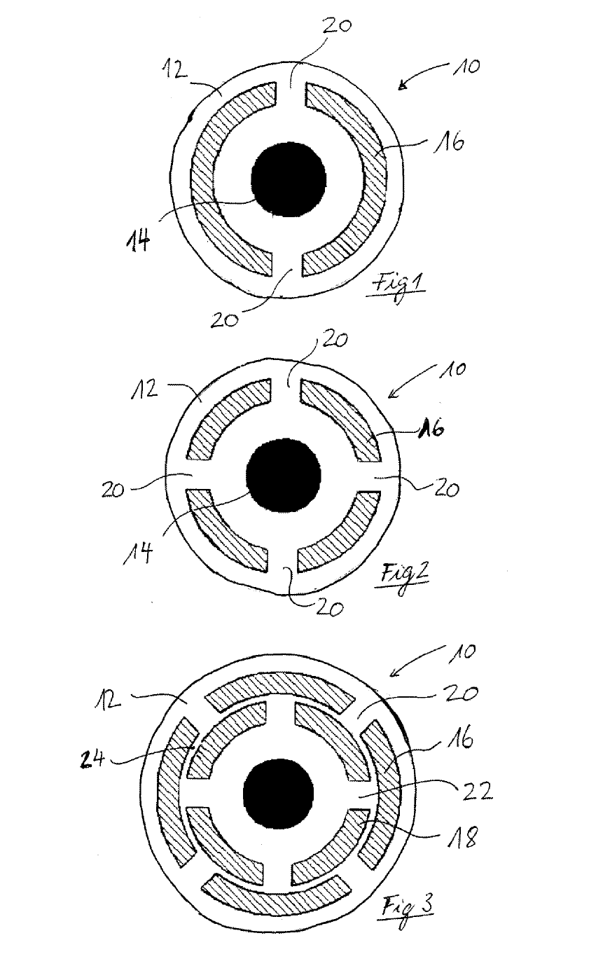

Referring to FIG. 1 a leakage detection patch 10 comprises a disk-shaped flexible polymer substrate 12 with an oxygen sensing spot 14 centrally applied thereon. The patch 10 further comprises a thin adhesive strip 16 applied on the substrate 12. The adhesive strip is provided with diametrically opposed openings 20 enabling oxygen diffusion. FIG. 2 shows a similar arrangement with four openings 20 disposed at angles of 90 degrees around the central sensing spot 14.

FIG. 3 shows a leakage detection patch 10 with two concentric rings of adhesive 16, 18 around the sensing spot 14. The adhesive rings 16, 18 have openings 20, 22 for oxygen diffusion. The openings 20 of the outer adhesive ring 16 are angularly staggered with respect to the openings 22 of the inner adhesive ring 18. The diffusion path therefore comprises narrow passages 24 between the outer ring 16 and the inner ring 18, which allow diffusion of gas, but inhibit the passage of liquid to the oxygen sensing spot 14.

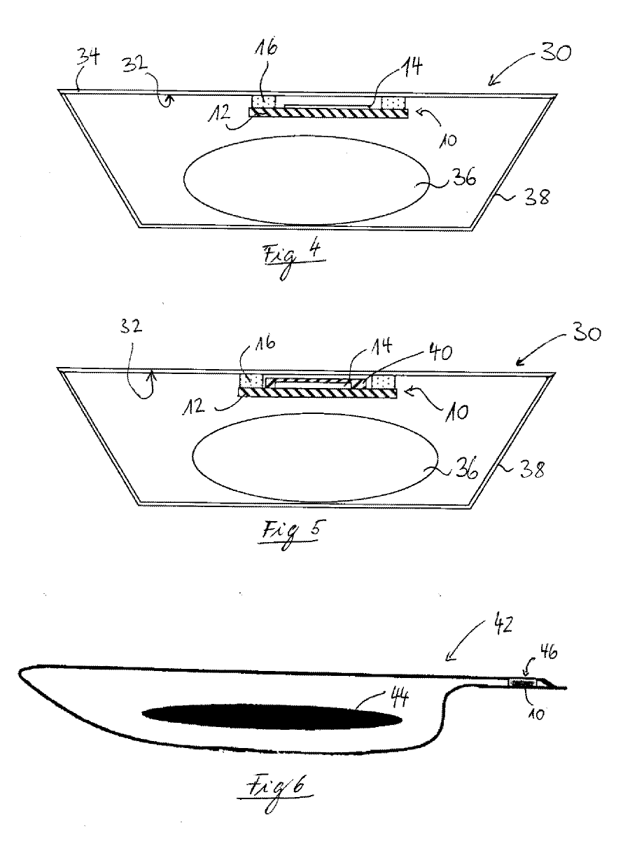

A modified atmosphere package 30 is shown in FIG. 4. A leakage detection patch 10 is fixed at the surface 32 of the transparent lidding foil 34, which faces the modified atmosphere. The leakage detection patch 10 comprises a substrate 12 and an oxygen sensing spot 14 applied on the substrate 12, on the surface facing away from the perishable good 36 in the tray 38.

Oxygen present in the modified atmosphere may diffuse through the substrate 12 or through openings in the adhesive 16. Oxygen leakage into the package 30 can be detected via an increased oxygen concentration. The oxygen sensing spot 14 comprises a fluorescent dye, which allows measuring oxygen concentration by determining intensity and/or lifetime of the fluorescence of the dye. For measurement, the oxygen-sensitive dye may be excited by a short light pulse (e.g. a laser pulse). After excitation, the dye emits fluorescent light with a decay curve, which depends on the oxygen concentration, according to the Stern-Volmer relations.

FIG. 5 shows another leak detection patch 10 attached to the inner surface 32 of a package 30. The patch 10 comprises a substrate 12, a sensing spot 14 and an adhesive 16 disposed around the sensing spot 14. The sensing spot 14 is sandwiched between an additional sealing layer 40 and the substrate 12. Oxygen may diffuse through the substrate 12, or penetrate to the sensing spot through openings provided in the adhesive 16 and the sealing layer 40.

As an alternative to the embodiment of FIG. 5, the sealing layer may cover substantially the whole surface of the substrate 12. In this case, the adhesive strip is applied on top of the sealing layer to fix the patch to the surface 32.

FIG. 6 shows an edge-sealed modified atmosphere package 42 bearing a product 44. The package 42 is edge-sealed with a seal 46 comprising a leakage detection patch 10. A broken seal can be remotely detected by optically interrogating the sensing spot of the leakage detection patch.

1.-9. (canceled)

10. A leakage detection patch for a modified atmosphere package comprising a substrate;
an oxygen sensing spot arranged on said substrate, said oxygen sensing spot containing an oxygen indicator; and
an adhesive strip extending peripherally around said sensing spot for fixing said leakage detection patch to a package surface of said modified atmosphere package, said adhesive strip having at least one opening therein for enabling oxygen diffusion between said modified atmosphere and said oxygen sensing spot.

11. A leakage detection patch according to claim 10, wherein said substrate is permeable for oxygen.

12. A leakage detection patch according to claim 10, wherein said adhesive strip has a plurality of openings therein, said openings being regularly arranged around the periphery of said sensing spot.

13. A leakage detection patch according claim 10, wherein said at least one opening has a labyrinthal shape.

14. A leakage detection patch according to claim 10, wherein said adhesive strip comprises at least a first and a second adhesive ring, said first and second adhesive rings being substantially concentric and spaced from each other; said first adhesive rings comprising at least one opening and said second adhesive ring comprising at least one opening, said openings being staggered in angular direction.

15. A leakage detection patch according to claim 10, said patch having an elongated shape.

16. A leakage detection patch according to claim 10, comprising a transparent sealing layer on top of said oxygen sensing spot.

17. A seal for a modified atmosphere package comprising a leakage detection patch, said leakage detection patch comprising
a substrate;
an oxygen sensing spot arranged on said substrate, said oxygen sensing spot containing an oxygen indicator; and
an adhesive strip extending peripherally around said sensing spot for fixing said leakage detection patch to a package surface of said modified atmosphere package, said adhesive strip having at least one opening therein for enabling oxygen diffusion between said modified atmosphere and said oxygen sensing spot.

18. A seal according to claim 17, wherein said substrate is permeable for oxygen.

19. A seal according to claim 17, wherein said adhesive strip has a plurality of openings therein, said openings being regularly arranged around the periphery of said sensing spot.

20. A seal according to claim 17, wherein said at least one opening has a labyrinthal shape.

21. A seal according to claim 17, wherein said adhesive strip comprises at least a first and a second adhesive ring, said first and second adhesive rings being substantially concentric and spaced from each other; said first adhesive rings comprising at least one opening and said second adhesive ring comprising at least one opening, said openings being staggered in angular direction.

22. A seal according to claim 17, said patch having an elongated shape.

23. A seal according to claim 17, comprising a transparent sealing layer on top of said oxygen sensing spot.
